(19) United States
(12) Patent Application Publication
(10) Pub. No.: US 2026/0305605 A1
(43) Pub. Date: Oct. 8, 2026

(54) SEEDS COATED WITH A REPELLENT VOLATILE ORGANIC COMPOUND (VOC) MIXTURE

(71) Applicant: AGRIODOR, Rennes (FR)

(72) Inventor: Landry SARLES, Pace (FR)

(21) Appl. No.: 19/483,361

(22) PCT Filed: May 7, 2024
(86) PCT No.: PCT/EP2024/062600

§ 371 Date: Nov. 11, 2025

(30) Foreign Application Priority Data
May 11, 2023 (FR) FR2304698

(51) Int. Cl. A01N 25/00; A01N 31/02; A01N 31/04; A01N 31/16; A01N 65/08; A01N 65/44; A01P 7/04

(52) U.S. Cl. CPC A01N 25/00; A01N 31/02; A01N 31/04; A01N 31/16; A01N 65/08; A01N 65/44; A01P 7/04

(57) ABSTRACT

The present invention relates to the coating of seeds for protecting plants against airborne insects, with a mixture of volatile organic compounds (VOCs) repellent for insects. It also relates to the seeds coated with such a mixture, the plant grown from the seeds coated with such a mixture, the method for protecting a plant against damage caused by airborne insect pests, which comprises the coating of the seeds of said plant with such a mixture and method for producing a plant which is repellent for an airborne insect pest liable to affect said plant.

### FIELD OF THE INVENTION

The present invention relates to the coating of seeds for protecting plants against airborne insects, with a mixture of volatile organic compounds (VOCs) repellent for insects. It also relates to the seeds coated with such a mixture.

### PRIOR ART

Protecting plants against insect pests is mainly based on the use of insecticidal molecules that have the advantage of effectively eliminating the pests, but the drawback of also eliminating other insects, such as pollinators, and forming residues that pollute the surrounding soil and water table. This is in particular the case with neonicotinoids, which act at small doses on the central nervous system of both harmful insects and pollinators.

Coating seeds with systemic insecticides, in particular neonicotinoids, is a known solution for protecting plants against airborne insect pests. This is a case in particular for protecting plants against attacks by aphids, and in particular protecting sugar beet cultivation for preventing the so-called yellows disease of sugar beet caused by the beet yellows virus or BYV, which is carried by aphids. The systemic insecticides that coat the seed diffuse in the various organs of the growing plant and kill the insects that come into contact with these organs, whether it be a case of pests, in particular stinging/sucking pests, or pollinating insects (Rundlöf, M. et al. Seed coating with a neonicotinoid insecticide negatively affects wild bees. Nature 521, 77-80 (2015)).

Legislations in various countries have led to a prohibition on the use of these insecticides, but it is important to be able to provide concrete and effective alternatives to insecticides to enable farmers to produce more durably.

The use of essential oils with regard to biocontrol for agriculture is known. Essential oils of various origins have been described for their herbicidal properties (Alipour et al. 2019), Fungicides or Bactericides (Yilmaz et al., 2021; Ben-Jabeur et al. 2019; De Clerc C. et al., Foods, 2020, 9 (10), 1418) or Insecticides (Mossa T H, J.; Environmental Science and Technology, 2016, 9(5), 354-378), Including Against Nematodes (Nguyen, M.-H et al., Archives of Phytopathology and Plant Protection 2022, 55 (4), 420-432).

The ability of certain VOCs to repel insects is known (WO 2006/040766), in particular through the use of essential oils, complex mixtures of VOCs (WO 1996/039827; Kowalska, J. et al., Molecules, 2021; Deletre et al., 2015; Obeng-Ofori et al., 1997; Araujo et al., 2012; Zhang et al., 2013) or certain mixtures that have repellent or attractive properties (WO 2016/077495; EP 3 031 322; EP 3 874 948; U.S. Pat. No. 4,880,624, WO 2004028256; WO 2011/045596; WO 2014/147110; US 2016/0302411; WO 2022/034085; Thöming G, Knudsen G K, Phytochemistry. 2014; 100:66-75; von Arx M et al., J Insect Physiol. 2011; 57(10):1323-31) or which induce defence mechanisms in plants liable to be attacked by insect pests (U.S. Pat. No. 8,221,736). Use thereof for repelling aphids is also described (Dardouri et al., Agricultural and Forest Entomology, 2019; Dardouri, Tarek, et al., Pest Management Science, 2019; Dardouri et al., IOBC-WPRS Bull, 2017; Hori, Masatoshi, Journal of Chemical Ecology, 1998).

Treating seeds with essential oils has also been described, in particular for preventing fungicidal attacks (U.S. Pat. No. 10,542,759; van der Wolf J. M. et al., Seed Sci. & Technol, 36, 76-88, 2008; Nguefack. J et al., American-Eurasian J. Agric & Environ. Sci., 4 (5),: 554-560, 2008; Marinelli E. et al., Asian Journal of Plant Pathology, 2012; Riccioni L. et Orzali L., Journal of Essential Oil Research, 2011).

However, if the use of the treatment of seeds with these essential oils is directed to preventing diseases on the seed before or after germination in the ground, no coating solution exists for preventing attacks by airborne insects that would make it possible to replace the treatments of seeds with insecticides of the neonicotinoid type.

One object of the present invention is to propose a seed coating solution for protecting plants against airborne insects.

### DESCRIPTION OF THE INVENTION

The invention relates to a coated plant seed for which the coating contains a VOC mixture repellent for an airborne insect pest for said plant.

The invention also relates to plant grown from the coated seed according to the invention, the plant being repellent for an airborne insect pest liable to affect said plant.

The invention also relates to a method for protecting a plant against damage caused by airborne insect pests, which comprises the coating of the seeds of said plant with a VOC mixture repelling said airborne insect pests liable to affect said plant.

The invention also relates to a method for producing a plant which is repellent for an airborne insect pest for said plant which comprises the steps of coating a plant seed with a repellent VOC mixture for an airborne insect pest liable to affect said plant and growing the plant from the said seed.

### DETAILED DESCRIPTION OF THE INVENTION

### Definitions

“Airborne insect” means an insect in its development phases out of the ground. It may be a case of a crawling insect or a flying insect.

“Insect pest” means an insect detrimental for agricultural plants (farms, market gardening) or horticultural plants (annual plants).

“Airborne insect pest” means an airborne insect the detrimental action of which takes place in its development cycle out of the ground, on the above-ground parts of the plants.

“Seed” means one or more seeds of a plant.

“Plant” means a plant variety cultivated for producing agricultural or horticultural plants.

“Volatile organic compound” or “VOC” means organic compounds volatile at ambient temperature.

“Volatile” means having a vapour pressure greater than 0.001 kPa.

“Ambient temperature” means a temperature ranging from 15 to 40° C., more generally from 20 to 30° C.

“VOC mixture” means a composition consisting of at least one VOC selected from allelochemical substances, in particular kairomones and allomones. It may comprise negligible traces of non-volatile impurities. The VOC mixture consists of at least 99% VOC(s), more generally 100% VOC(s). The VOC mixture may be a “natural VOC mixture” or a “synthetic VOC mixture”.

“Natural VOC mixture” means a natural extract consisting of VOCs, particularly an essential oil extracted from a plant. Natural VOC mixtures and particularly essential oil extracts comprise mixtures of more than one VOC.

“Synthetic VOC mixture” or so-called “manufactured VOC mixture” means a composition not found as such in nature. The definition encompasses compositions consisting of at least one VOC, meaning 1 single VOC or at least 2, 3, 4, 5, 6, 7 VOCs, or more. Said at least one VOC is a synthetic VOC, obtained by chemical synthesis, or a VOC purified from a mixture. A synthetic mixture of 2 VOCs or more is obtained by mixing VOCs that are pure or already in mixtures with other VOCs.

“Kairomones” are VOCs produced by an emitting living organism, which produce an effect favourable for another so-called receptor living organism, when they are released into the environment.

“Allomones” are VOCs produced by individuals of a first, so-called emitting, species that cause, in the individuals of another, so-called receptor, species a favourable reaction to the emitting species.

“Repellent VOC mixture” means a VOC mixture of known composition, selected for its repellent properties vis-à-vis an airborne insect pest.

“VOC mixture repellent for an airborne insect pest to a plant” means a repellent VOC mixture selected for its ability to repel an insect pest susceptible to attack the aerial parts of a plant grown from the seed being coated.

“Carrier” means a carrier enabling the repellent VOC mixture to be applied to seeds. The carrier is inert vis-à-vis the VOC mixture and the seed, i.e. it neither affects the VOCs of the mixture nor presents any phytotoxicity vis-à-vis the seed.

Unless indicated to the contrary, the percentages, contents and ratios are expressed by weight.

An indication of numerical ranges by the end points is intended to include all the numbers included in this range (for example a recitation of 1 to 5 comprises in particular 1, 1.25, 1.5, 1.75, 2, 2.45, 2.75, 3, 3.80, 4, 4.32, 4.45 et 5).

The term “approximately” is used here explicitly or not. Each quantity given in the present description refers to the given real value, and to the approximation of this given value that would be reasonably deduced on the basis of the ordinary competences of the art, including equivalents and approximations due to experimentation and/or measurement conditions for this given value. In general, the term “approximately” in the context of a given value refers to said value and to a range that encompasses said value by +/−5% of said given value, in particular by +/−1%.

### Coating of Seeds

Seed coating techniques are well known to persons skilled in the art (Afzal et al., 2020). They must meet various constraints that relate to the form of the seed, size, weight and shape, the coating method and the coating composition selected. The coating must be adapted to the agricultural techniques particular to the sowing of the plant in question, in particular for avoiding losses. The main coating techniques known are described below.

Dry powder coating (Taylor 2003): In this method, a dry powder formulation containing the chemical products for treating the seeds required is applied to the seeds. The powder adheres to the surface of the seed, forming a fine protective layer. This method is simple and economical, but may not provide uniform coverage or protection of long duration.

Seed dressing (Kimmelshue et al., 2019): The treatment of the seeds consists in applying a liquid formulation of chemical seed-treatment products to the seeds. The liquid is absorbed by the seed, offering protection against pests and diseases. This method offers uniform coverage and good protection, but may require specialised equipment and careful manipulation.

Film coating (Taylor 2003): Film coating consists in applying a fine layer of polymer or other protective material to the seed. The layer of film can provide protection against environmental stresses, such as drought or extreme temperatures, as well as against parasites and diseases. This method offers good protection and can also be used for adding nutriments or other compounds beneficial to the seed.

Encrusting (Taylor 2020): Encrusting consists in coating the seed with a mixture of chemical seed-treatment products and a binder, such as clay or a polymer. The mixture is applied to the seed and left to dry, forming a hard shell around the seed. This method offers good protection against pests and diseases, as well as against environmental stresses, and can also be used for adding nutriments or other compounds beneficial to the seed.

Pelleting (Pedrini et al., 2017): Pelleting consists in coating the seed with a mixture of chemical seed-treatment products and a binder, such as clay or a polymer, and then compressing the mixture into small granules. The granules are next applied to the seed, offering uniform coverage and protection against pests and diseases. This method is particularly useful for manipulating small or irregularly shaped seeds.

The repellent VOC mixture is applied to the seeds with a suitable carrier. Numerous carriers adapted to the above coating techniques are known. These are products of natural or synthetic origin, biosourced or not, organic or mineral, alone or in mixtures. Mention can be made of the mixtures described in various patent applications based on waxes, starch, micronized minerals, and other polymers, cross-linked or not, water, etc. (WO 2023/281280, WO 2022/219331, WO 2022/177749, WO 2022/155846, WO 2021/160886, WO 2021/156116, WO 2021/144430, WO 2021/035665, WO 2021/013929, WO 2019/246031, WO 2019/099764, WO 2018/096394, WO 2018/022557, WO 2017/081535, WO 2017/067833, WO 2017/043364, WO 2016/167314, WO 2016/167314, WO 2016/013506, WO 2015/146869, WO 2015/118479, WO 2015/066153, US 2022/0154030, US 2018/0325104, US 2018/0303023, US 2018/0184646, US 2018/0124995, US 2017/0142894, US 2015/0299057).

A person skilled in the art will be able to select the carrier and the coating technique adapted to the seeds that will be treated.

The quantity of VOC mixture per seed is approximately 1 g to approximately 50 g of VOC mixture for 100,000 grains of seed, more particularly approximately 1 g to approximately 20 g of VOC mixture for 100,000 grains. In particular, this quantity of VOC mixture is approximately 1, 2, 3, 4, 5, 6, 7, 8, 9, 10, 11, 12, 13, 14, 15, 16, 17, 18, 19 or 20 g for 100,000 grains. According to a particular embodiment, the quantity of VOC is approximately 5 g to approximately 15 g of VOC mixture for 100,000 grains, more particularly approximately 8 to approximately 12 g for 100,000 grains.

### Plants, Airborne Insects and VOC Mixture

The VOC mixture for coating seeds according to the invention is selected for its ability to repel known airborne insect pests from the plants resulting from these seeds. It is a repellent VOC mixture.

Among the plants used in agriculture, mention will be made of the crop plants and gardening plants, in particular Apiaceae (Umbellifers), such as carrots, celery or radish, or aromatic plants such as parsley, fennel, angelica, cumin; Asteraceae, comprising oleaginous plants such as sunflower, oleaginous plants or market-gardening plants such as lettuce, chicory, endive, artichoke, salsify, scorzonera, or aromatic, medicinal or ornamental plants such as asters or chrysanthemums; brassicas (cruciferous vegetables), comprising oleaginous plants such as rapeseed, or vegetable brassicas; Chenopodaceae such as beetroots, spinach, beet or chard; Cucurbitaceae, such as melons, marrows, courgettes, cucumbers, gherkins, pumpkins, watermelons; Fabaceae (leguminous) on farms such as soya, clover, sainfoin, alfalfa, vetch, proteinaceous peas, horse bean or lupine, market-gardening cultivation such as beans, peas, lentils or broad beans; Liliaceae (Aliaceae), such as leeks, onions, shallots, garlic or asparagus; Poaceae, including cereals, wheat, barley, oats or rye, forage grasses, orchard grass, fescue, timothy, ray grass or maize; Solanaceae such as potatoes, tomatoes, aubergines and chillies.

Among farm plants or industrial cultivations, mention will be made in particular of maize, wheat, barley, rapeseed, beetroot and pea. Among market-garden plants, mention will be made in particular of carrots, lettuce, leeks, chillies and tomatoes.

Among airborne insect pests, mention will be made of the insects known by the names thrips (Thysanoptera), flea beetles, flies, olive moths (Acrolepiopsis), cochineals, noctuid moths and aphids. Among these usual names of airborne insects, various families, classes or genera of insects identified as plant pests will be found. Among thrips mention will be made of Echinothrips americanus, Frankliniella occidentalis and Thrips tabaci. Among flea beetles, mention will be made of Psylliodes chrysocephala, Phyllotreta nemorum, Chaetocnema concinna, Aphtona euphorbiae and Longitarsus parvulus. Among flies, mention will be made of leafminer flies, whiteflies or Aleyrodoideae, and fruit flies.

In particular, a mixture of repellent VOCs will be used for the following combinations of plants and airborne insect pests: beetroot/aphid, lettuce/aphid (in particular green aphid), chillies/aphid (in particular green aphid), pea/aphid (in particular green pea aphid), tomato/thrips, carrot/fly (in particular carrot fly), leak/fly (in particular leak leafminer fly) and/or leak/olive moth (in particular leak olive moth), wheat/aphid and/or wheat/fly (in particular grey cereal fly), rapeseed/flea beetle (in particular rapeseed flea beetle).

VOC mixtures and the repellent action thereof on various airborne insects are in particular described in the patent applications EP 0 629 345, US 2016/0255833, WO 2021/155257 and WO 2021/041927 and in the previously cited references.

According to one embodiment, the repellent VOC mixture is a natural repellent COV mixture.

Among the natural repellent COV mixtures, mention will be made of the essential oils of rue (Ruta graveolens), thyme (Thymus vulgaris), citronella (Cymbopogon citratus) cumin (Cuminum cyminum), lavender (Lavandula×Intermedia), verbena (Verbena officinalis), geranium (Pelargonium sp), mint, in particular green mint (Mentha spicata) and peppermint (Mentha×piperita), eucalyptus, in particular lemon eucalyptus (Corymbia citriodora) and eucalyptus globulus, cedar (Cedrus libani), clove (Syzygium aromaticum), rosemary (Rosmarinus officinalis), garlic (Allium sativum), celery (Apium graveolens), juniper (Juniperus communis), nepeta (Nepeta spp), oregano (Origanum vulgare), 7 asserine 7 (Cymbopogon citratus), pepper, (Piper spp), cinnamon (Cinnamomum spp), Chinese cinnamon (Cinnamomum cassia), caraway (Carum carvi), Moldavian dragonhead (Dracocephalum moldavicum), fennel (Foeniculum vulgare), hyssop (Hyssopus officinalis), lemon balm (Melissa officinalis), basil (Ocimum basilicum), sage (Salvia spp), coriander (Coriandrum sativum), clove (Syzygium aromaticum), Neem tree (Azadirachta indica), French marigold (Tagetes patula) and dill (Anethum graveolens). The essential oils can be employed alone and in mixtures.

According to a particular embodiment, mention will be made, for repelling flea beetles, in particular for rapeseed, a coating with an essential oil selected from the essential oils of Ruta graveolens, Thymus vulgaris, Cymbopogon citratus, Cuminum cyminum, Lavandula, Verbena officinalis, Pelargonium sp, Mentha spicata, Mentha×piperita, Corymbia citriodora, Cedrus libani, Syzygium aromaticum, Rosmarinus officinalis and Eucalyptus globulus, used alone or in mixtures.

According to another particular embodiment, mention will be made, for repelling thrips, in particular for tomatoes, coating with the essential oils of Rosmarinus officinalis, Allium sativum, Apium graveolens, Juniperus virgiana, Mentha spicata, Nepeta Cataria, Litsea cubeta, Satureja montana, Thymus vulgaris, Thymus serpyllum, Origanum compactum, Cymbopogon schoenanthus, Piper nigrum, Cinnamorum verum, Cinnamomom cassia and Origanum majorata, used alone or in mixtures.

According to another particular embodiment, mention will be made, for repelling aphids, in particular for beetroot and chillies, a coating with the essential oils of Carum carvi, Citrus sinensis (L.) Osbeck, Dracocephalum kotschyi, Eucalyptus globulus Labill., Foeniculum vulgare Mill, Hyssopus officinalis, Lavandula angustifolia, Melissa officinalis L, Mentha piperita, Mentha pulegium Mill., Ocimum basilicum L, Majorana hortensis L., Origanum vulgare, Pimpinella anisum, Thymus capitatus, Verbena officinalis L, Hemizygia 8 asserine, Melissa officinalis, Salvia officinalis, Coriandrum sativum, Cinnamomum verum, Syzygium aromaticum, Azadirachta indica, Tagetes erecta, Allium sativum and Ruta graveolens, used alone or in mixtures.

According to yet another embodiment, mention will be made, for repelling the pea green aphid, a coating with the essential oils of Cinnamomum cassia, Mentha×piperita) Pimpinella anisum, Ocimum basilicum, Mentha spicata, Anethum graveolens, used alone or in mixtures.

A person skilled in the art will be able to select, as a repellent VOC mixture used for coating seeds according to the invention, the essential oil with respect to the airborne insect pest targeted, in particular according to the combinations of plants and airborne insect pests described previously.

According to another embodiment, the repellent VOC mixture is a synthetic VOC mixture.

According to one embodiment, the synthetic repellent VOC mixture consists in one single VOC.

According to another embodiment the synthetic repellent VOC mixture comprises from 2 to 5 different VOCs, 2, 3, 4 or 5 different VOCs, the proportions of which will vary according to the airborne insect pest targeted.

The VOCs used in the synthetic mixture according to the invention may be of natural origin, extracts of plants in particular, or synthetic. Whether they are of natural or synthetic origin, the VOCs used in the mixture according to the invention have a purity of at least 95%, advantageously at least 96%, at least 97%, at least 98%, at least 99%.

The VOCs used in a mixture for repelling airborne insect pests comprise in particular eugenol, linalool, cinnamaldehyde, in particular trans-cinnamaldehyde, geraniol, caryophyllene, para-cymene, gamma-terpinene, alpha-terpinene, alpha-phellandrene, zingiberene, nerolidol, farnesol, geraniol, anisaldehyde, coumarin, methyl jasmonate, cis-jasmone, salicylaldehyde, alpha-pinene, eucalyptol, monoterpenoide citral, 6-2-hexenal, limonene, in particular (S)-limonene @(R) limonene, myrcene, in particular beta-myrcene or alpha-myrcene, carvone, in particular (S)-carvo@or (R)-carvone, nerol, in particular trans-nerol or cis-nerol, and carvacrol. The VOCs, the formulae thereof, the effects thereof on various insects and the references to the articles that describe them are found in particular on the website https://www.pherobase.com, in particular kairomones (https://www.pherobase.com/database/compound/compounds-behav-kaines.php), allomones (https://www.pherobase.com/database/compound/compounds-behav-allnes.php), and those identified as repellent (https://www.pherobase.com/database/compound/compounds-behav-repnts.php).

According to a particular embodiment of the invention, the repellent VOC mixture is a repellent mixture for aphids. The invention is a plant seed liable to be affected by aphids, coated with a VOC mixture repellent for aphids.

Among the aphids that attack cultivations of these plants, mention will be made of the aphids of the genera Acyrthosiphon (Acyrthosiphon pisum, Acyrthosiphon malvae), Aphis (Aphis lambersi, Aphis spiraecola, Aphis fabae, Aphis gossypii, Aphis nastutii, Aphis craccivora, Aphis forbesi, Aphis frangulae), Aulacorthum (Aulacorthum solani, Aulacorthum circumflexum), Brachycaudus (Brachycaudus helichrysl), Brevicoryne (Brevicoryne brassicae), Cavariella (Cavariella aegopodil), Chaetosiphon (Chaetosiphon (Pentatrichopus) fragaefolii), Diuraphis (Diuraphis spp), Dysaphis (Dysaphis apifolia, Dysaphis crataegi, Dysaphis plantaginea), Hyadaphis (Hyadaphis foeniculi, H 9 asserinepasserini), Lypaphis (Lipaphis erysimi), Macrosiphum (Macrosiphum euphorbiae), Megoura (Megoura viciae), Metopolophium (Metopolophium dirhodum, Metopolophium festucae), Myzus (Myzus persicae, Myzus ascalonicus, Myzus ornatus), Nazonovia (Nazonovia ribisnigril), Neactaphis (Nearctaphis bakeri), Neotoxptera (Neotoxoptera formosana, Neotoxoptera olivern), Rhodobium (Rhodobium porosum), Rhopalosiphoninus (Rhopalosiphoninus staphyleae, Rhopalosiphum padi, Rhopalosiphum insertum, Rhopalosiphum maidis, Rhopalosiphoninus latysiphon), Schizaphis (Schizaphis graminum), Semiaphis (Semiaphis daucl), Sipha (Sipha (Rungsia) elegans, Sipha (Rungsia) maydis), Sitobion (Sitobion avenae, Sitobion fragariae), Smynthurodes (Smynthurodes betae), Trama (Trama spp) and Therioaphis (Therioaphis trifolil).

Aphids are known to affect wide varieties of plants, in particular Apiaceae (Umbellifers), such as carrots, celery or radish, or aromatic plants such as parsley, fennel, angelica, cumin; Asteraceae, comprising oleaginous plants such as sunflower, oleaginous plants or market-gardening plants such as lettuce, chicory, endive, artichoke, salsify, scorzonera, or aromatic, medicinal or ornamental plants such as asters or chrysanthemums; brassicas (cruciferous vegetables), comprising oleaginous plants such as rapeseed, or vegetable brassicas; Chenopodaceae such as beetroots, spinach, beet or chard; Cucurbitaceae, such as melons, marrows, courgettes, cucumbers, gherkins, pumpkins, watermelons; Fabaceae (leguminous), on farms such as soya, clover, sainfoin, alfalfa, vetch, proteinaceous peas, horse bean or lupine, market-gardening cultivation such as beans, peas, lentils or broad beans; Liliaceae (Aliaceae), such as leeks, onions, shallots, garlic or asparagus; Poaceae, including cereals, wheat, barley, oats or rye, forage grasses, orchard grass, fescue, timothy, ray grass or maize; Solanaceae such as potatoes, tomatoes, aubergines and chillies.

The repellent VOC mixture used for coating seeds for preventing attacks by aphids comprises at least linalool and eugenol.

Linalool (CAS No: 78-70-6) is a product of natural origin that is found abundantly in natural oils such as essential oils of bergamot, lavender or rosewood. It is also produced by chemical synthesis.

Eugenol (CAS No: 97-53-0), also called 4-allyl-2-methoxyphenol, is a product of natural origin that is found abundantly in natural oils such as clove oil. It is also produced by chemical synthesis.

According to the invention, the VOC mixture comprises less linalool than eugenol.

According to one embodiment, the linalool/eugenol weight ratio ranges from approximately ¼ to approximately ⅔, and in particular approximately 2/7, approximately ⅓, approximately ⅜, approximately ⅖, approximately 3/7, approximately 4/9, approximately ½, approximately 5/9 and approximately ⅗. In particular, the linalool/eugenol weight ratio is between any one of these fractions, in particular between approximately 2/7 and approximately ½, between approximately ⅓ and approximately 5/9, and between approximately ⅜ and approximately ⅗. According to a particular embodiment, the linalool/eugenol weight ratio is at least approximately ⅓, in particular at least approximately ⅜, more particularly at least approximately ⅖. According to another particular embodiment, the linalool/eugenol weight ratio is less than approximately ½, in particular less than approximately 4/9. According to another particular embodiment, the linalool/eugenol weight ratio ranges from approximately ⅜ to approximately 4/9. Advantageously, the linalool/eugenol weight ratio is approximately ⅖ or approximately 3/7.

According to a particular embodiment, the VOC mixture comprises at least linalool, eugenol and cinnamaldehyde, in particular trans-cinnamaldehyde.

Trans-cinnamaldehyde (CAS No: 104-55-2), or cinnamic aldehyde, also called 3-phenylpropenal, is a product of natural origin that is found abundantly in natural oils such as essence of cinnamon. It is also produced by chemical synthesis.

The proportion of trans-cinnamaldehyde in the VOC mixture is less than or equal to the proportion of linalool+eugenol mixture, preferably less.

According to one embodiment, the trans-cinnamaldehyde/(linalool+eugenol) weight ratio ranges from approximately 2/7 to approximately 1/1, and in particular approximately ⅓, approximately ⅜, approximately ⅖, approximately 3/7, approximately 4/9, approximately ½, approximately 5/9, approximately ⅗ and approximately ⅔. In particular, the trans-cinnamaldehyde/(linalool+eugenol) weight ratio is between any one of these fractions, in particular between approximately ⅓ and approximately ⅗, between approximately ⅜ and approximately 5/9, and between approximately ⅖ and approximately ½. According to a particular embodiment, the trans-cinnamaldehyde/(linalool+eugenol) weight ratio is at least approximately ⅓, in particular at least approximately ⅜, more particularly at least approximately ⅖. According to another particular embodiment, the trans-cinnamaldehyde/linalool+eugenol weight ratio is less than approximately 5/9, in particular less than approximately ½, even more particularly less than approximately 4/9. According to another particular embodiment, the trans-cinnamaldehyde/linalool+eugenol weight ratio ranges from approximately ⅖ to approximately ½. Advantageously, the trans-cinnamaldehyde/linalool+eugenol weight ratio is approximately 3/7.

In this definition, the quantity of linalool and of eugenol in the linalool+eugenol+trans-cinnamaldehyde mixture is preferably in a linalool/eugenol weight ratio as defined above.

The VOC mixture according to the invention may comprise other VOCs selected from kairomones and allomones. Geraniol and caryophyllene will in particular be cited.

In a particular embodiment, the proportion of linalool and eugenol (linalool+eugenol) is at least 30% by weight of the total weight of the VOC mixture, more particularly at least 35%, 40%, 45% or 50% by weight. According to a more particular embodiment, the proportion of linalool and eugenol is at least 60% by weight of the total weight of the VOC mixture, more particularly at least 65% to 100%.

In a particular embodiment, the proportion of linalool is ranging from 5% to 40% by weight of the total weight of the VOC mixture, more particularly ranging from 15% to 35% by weight of the total weight of the VOC mixture, even more particularly ranging from 15% to 25% by weight of the total weight of the VOC mixture. In a particular embodiment, the proportion of linalool is about 20% by weight of the total weight of the VOC mixture.

In a particular embodiment, the proportion of eugenol is ranging from 25% to 80% by weight of the total weight of the VOC mixture, more particularly ranging from 40% to 75% by weight of the total weight of the VOC mixture, even more particularly ranging from 45% to 55% by weight of the total weight of the VOC mixture. In a particular embodiment, the proportion of eugenol is about 50% by weight of the total weight of the VOC mixture.

In a particular embodiment, the proportion of trans-cinnamaldehyde is at most 50% by weight of the total weight of the VOC mixture, more particularly at most 45%, 40%, 35%, 30%, 25%, 20%, 15%, 10% or 5% by weight of the VOC mixture. In a particular embodiment, the proportion of trans-cinnamaldehyde is about 30% by weight of the total weight of the VOC mixture. In a particular embodiment, the proportion of trans-cinnamaldehyde is ranging from 10% to 40% by weight of the total weight of the VOC mixture, more particularly ranging from 25% to 35% by weight of the total weight of the VOC mixture.

According to one embodiment, the VOC mixture comprises
a. 5 to 40% linalool, in particular 15 to 35%
b. 25 to 80% eugenol, in particular 40 to 75%
c. 0 to 50% trans-cinnamaldehyde, in particular 10 to 40%
the sum of a+b+c being less than or equal to 100% and the relative proportions of each constituent being defined above.

According to a particular embodiment of the invention, the VOC mixture comprises
a. 15 to 25% linalool, in particular approximately 20%
b. 45 to 55% eugenol, in particular approximately 50%
c. 25 to 35% trans-cinnamaldehyde, in particular approximately 30%,
the sum of a+b+c being equal to 100%.

When the sum of a+b+c is less than 100%, the mixture comprises other VOCs, more particularly other kairomones or allomones described previously in relative quantities the sum of a+b+c of which equals 100%.

Mention will be made in particular of a composition comprising
a. 5 to 20% linalool,
b. 25 to 40% eugenol,
c. 30 to 45% trans-cinnamaldehyde,
d. 5 to 15% geraniol, and
e. 5 to 15% caryophyllene
the sum of a+b+c+d+e being equal to 100%.

The invention is more particularly appropriate for preventing damage caused by aphids on Chenopodiaceae, in particular beetroots, more particularly sugar beets. It relates to seeds of these plants coated with a VOC mixture repelling aphids as defined previously.

The invention also relates to plant grown from the coated seed according to the invention, the plant being repellent for an airborne insect pest liable to affect said plant.

The invention also relates to a method for protecting a plant against damage caused by airborne insect pests, which comprises the coating of the seeds of said plant with a VOC mixture repelling airborne insect pests liable to affect said plant, as defined above.

The invention also relates to a method for producing a plant which is repellent for an airborne insect pest for said plant which comprises the step of coating of a plant seed with a repellent VOC mixture for an airborne insect pest liable to affect said plant and allowing the plant to grow from the said seed.

Growing the plant form the seed or allowing a plant to grow form a seed is common practice in agriculture with different known methods wherein the seed is put in condition to germinate in a medium comprising nutriments necessary for the development of the plant. It includes growing the plants in fields, including sowing a field directly with the seeds or sowing first in buckets or a soil in a protected area before transplanting the plantlets in the field where the plants will grow. It also includes growing the plants in controlled environments in greenhouses, either in a soil or soilless, such as hydroponics or aeroponics.

“Protecting plants against damage caused by insect pests” means the action of repelling the insect pests on the cultivated plots. This action can be measured by the reduction in the number of aphids on a cultivated plot compared with a non-treated plots. This number of aphids must be reduced by at least 30%, advantageously by at least 50% or more.

“Affecting the plant” may result in delays in growth, or even a stoppage of growth, and where applicable the death thereof. Affecting the plant, for cultivation and market-garden plants, results in a loss of yield for the grower, whether it is a case of a smaller quantity produced or of products unsuitable for consumption.

As needed, the plants resulting from sowings of seeds coated according to the invention can be treated with additional treatments, in particular additional treatments with the diffusion of additional repellent or attractive mixtures so as to remove the same airborne insect pests from the cultivated plants.

According to one embodiment, the additional repellent mixture may be the same as the repellent mixture employed for coating the seeds.

These additional treatments may be done by means of diffusion carriers such as granules or any other type of diffusion matrix such as paper, cardboard or plastic carriers that are impregnated with the VOC mixture, polymers, porous ceramics or materials based on natural fibres or slow-release diffusers, for example capsules, sachets or impregnated strips that slowly release the substance in the air, or electric diffusers that use heat or vibrations for diffusing the VOCs, or atomisation diffusers that vaporise the VOCs in the form of fine droplets in the air, or gel diffusers (gel or paste) the gel of which solidifies at ambient temperature and slowly releases the VOCs in the air, or other types of diffusion carrier for VOCs, such as ultrasound diffusers, membrane diffusers, pellet diffusers, etc.

### DESCRIPTION OF THE FIGURES

FIG. 1 shows the experimental device for evaluating the behaviour of aphids vis-à-vis plants resulting from seeds coated according to the invention (1) and plants resulting from untreated seeds (2, separated by a cardboard bridge (4) at the middle of which the aphids (3) are disposed, the whole being isolated from the outside by a cage covered with cellophane (5).

FIG. 2 shows three diagrams of results at 24 hr and 48 hr with a first diagram called “blend vs cntrl” that shows the counting of the aphids on the plants resulting from seeds coated according to the invention designated by “blend” and plants resulting from untreated seeds, designated by “cntrl”, and two diagrams presenting the results of the Mann-Whitney test at 24 hr and 48 hr, called respectively “blend vs cntrl 24 h” and “blend vs cntrl 48 h” with respectively a p-value of 0.006 and 0.009.

### EXAMPLES

The following examples illustrate the invention and the implementation thereof for a repellent VOC composition on sugar beet plants in the presence of aphids or on rapeseed seeds in presence of rapeseed flea beetle.

### Example 1

1) Coating of Beetroot Seeds with Cellulose Microfibres and a VOC Mixture

### Equipment:

100 bare beetroot seeds (m=1.470 g) are placed in the aluminium cup.
Granulation agent: 3 g of cellulose microfibres (Arbocell BC-200)
Binding agent: 2 g sugar cane molasses at 75% w/w (25% H₂O).
VOC mixture: linalool/eugenol/trans-cinnamaldehyde (2/5/3)

### Steps:

1) Spraying of binding agent onto the seeds, 0.5 g of 75% w/w molasses
2) Putting the granulation agent in the polisher
3) Transferring the seeds into the polisher containing the granulation agent and mixing.
4) Isolating the coated seeds (first layer) with an adapted sieve.
5) Repeating steps 1 to 4 until the molasses has been completely sprayed. The layer of cellulose on the seeds becomes thicker and thicker.
6) Repeating steps 1 to 4 but using an emulsion of 3 g molasses 75% w/w+11.1 μl of VOC mixture.
7) Repeating steps 1 to 4 but using 1 g of molasses 75% w/w.
8) Adding 4 g of talc powder in the polisher and mixing.
9) Isolating the 100 beads obtained of the excess talc.
2) Study of Behaviour of the Aphids

The aphids choose between a plant resulting from a seed without VOC coating versus plants resulting from seeds with VOC coating.
Animal equipment: wingless green aphids coming from a 24 hr or 48 hr cohort
Plant equipment: beetroot plants having the same sowing dates and same stage of development (4 leafs). No VOCs are detected in the air around the beetroot plants.

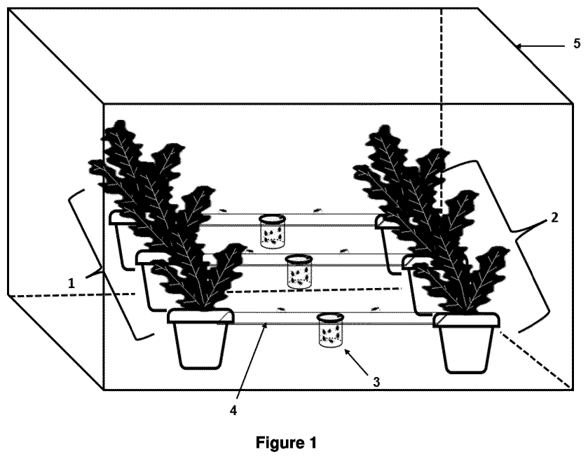

The behaviour of the aphids is studied by a device shown on FIG. 1. The plants coming from treated and untreated seeds are disposed in pairs, connected by a cardboard bridge at the middle of which the aphids are placed. After 24 hr and then after 48 hr the aphids will be counted on the various plants at the same time.

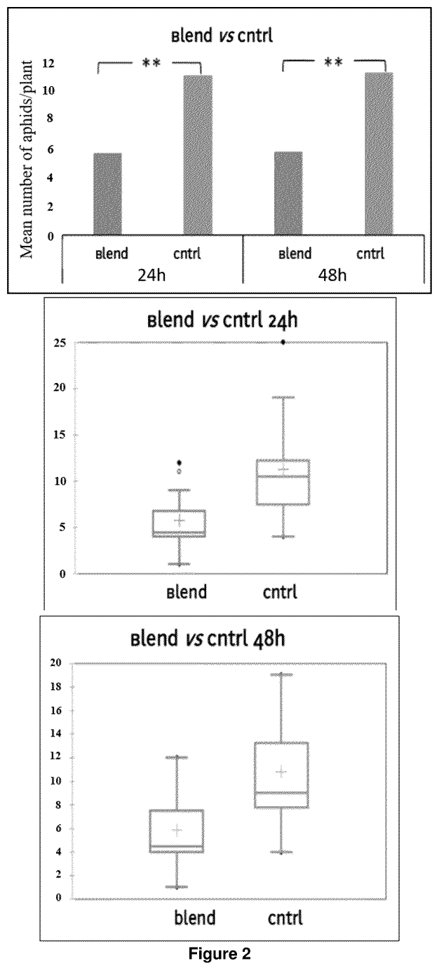

The results at 24 hr and 48 hr shown on FIG. 2 show a significantly greater presence of the number of aphids on the plants coming from uncoated seeds (references) compared with the plants coming from coated seeds (invention).

### Example 2

1) Coating of Rapeseed Seeds with Cellulose Microfibres and Different VOC Mixtures

5 different coated rapeseed seeds are prepared according to the procedure of example 1.

| Rapeseed | |
|---|---|
| seeds | VOC mixture |
| A | nerol |
| B | (R)-carvone |
| C | linalool/eugenol/trans-cinnamaldehyde/geraniol/caryophyllene |
| | (1/3/4/1/1) |
| D | linalool/eugenol/trans-cinnamaldehyde (2/5/3) |
| E | — |

### Control:

Rapeseed seeds without coating
Coated rapeseed seed E (without VOC)

### 2) Study of Behaviour of the Flea Beetle

Animal equipment: Psylliodes chrysocephala, rapeseed flea beetle, adult
Plant equipment: Brassica napus, rapeseed, 4-leaf stage. No VOCs are detected in the air around the plant.

The behaviour of the aphids is studied by a device shown on FIG. 1.

Two rapeseed plants were placed in a Plexiglas cage. The plants were placed two by two in Plexiglas boxes (one treated rapeseed seed and one control) and five flea beetles were placed in the centre of the cage in a Petri dish. After 96 hours, the leaves will be carefully cut and photographed next to a ruler on graph paper. The number and size of bites and the leaf area will be measured using ImageJ software.

The results are reported in Table 1 below:

TABLE 1

| | Number of | Total surface |
|---|---|---|
| Seed | bites per leaf | of bites (mm²) |
| A | 1.0 | 0.1 |
| B | 5.0 | 0.4 |
| C | 1.0 | 0.0 |
| D | 2.0 | 0.1 |
| Control (untreated) | 8.0 | 0.5 |
| Control (Coating without VOC) | 15.0 | 0.4 |

The results shown in Table 1 show that the number of bites per leaf fell significantly in plants grown from VOC coated seeds (A to D) compared with controls (plants grown from uncoated seeds and coating without VOC). Similarly, the total surface of bites was much smaller on VOC coated plants than on control plants. Thus, plants grown from seeds coated with volatile organic compounds (A to D) are therefore less attractive as food than those grown from uncoated seeds or coated seeds without VOC.

### REFERENCES

Aharoni, A., Giri, A. P., Deuerlein, S., Griepink, F., de Kogel, W. J., Verstappen, F. W., Verhoeven, H. A., Jongsma, M. A., Schwab, W. & Bouwmeester, H. J. (2003). Terpenoid metabolism in wild-type and transgenic Arabidopsis plants. Plant Cell 15(12): 2866-2884.
Araujo M J, Camara C A, Born F S, Moraes M M and Badji C A, Acaricidal activity and repellency of essential oil from Piper aduncum and its components against Tetranychus urticae. Exp Appl Acarol 57:139-155 (2012).
Bruce, T. J. A., Birkett, M. A., Blande, J., Hooper, A. M., Martin, J. L., Khambay, B., Prosser, I., Smart, L. E. & Wadhams, L. J. (2005). Response of economically important aphids to components of Hemizygia petiolata essential oil. Pest Management Science 61(11): 1115-1121.
Bruce, T. J., & Pickett, J. A. (2011). Perception of plant volatile blends by herbivorous insects-finding the right mix. Phytochemistry, 72(13), 1605-1611.
Bruce, T. J., Wadhams, L. J., & Woodcock, C. M. (2005). Insect host location: a volatile situation. Trends in plant science, 10(6), 269-274.
Bruno, D., Grossi, G., Salvia, R., Scala, A., Farina, D., Grimaldi, A., Zhou, J. J., Bufo, S. A., Vogel, H., Grosse-Wilde, E., Hansson, B. S. & Falabella, P. (2018). Sensilla Morphology and Complex Expression Pattern of Odorant Binding Proteins in the Vetch Aphid Megoura viciae (Hemiptera: Aphididae). Front Physiol 9: 777.
Chapman, R. F., Bernays, E. A. & Simpson, S. J. (1981) Attraction and repulsion of the aphid, Cavariella aegopodii, by plant odors Journal of Chemical Ecology, 7, 881-888
Clavijo Mccormick, Andrea., Gershenzon, J., & Unsicker, S. B. (2014). Little peaks with big effects: establishing the role of minor plant volatiles in plant-insect interactions. Plant, cell & environment, 37(8), 1836-1844.
Dardouri, T. (2018). Involvement of volatile organic compounds in the ability of service plants to interfere with the behaviour and performances of Myzus persicae (Sulzer), the orchard green aphid. Avignon.
Dawson G W, Griffiths D C, Pickett J A, Smith M C and Woodcock C M, Natural inhibition of the aphid alarm pheromone. Entomol Exp Appl 36:197-199 (1984).
Deletre E, Chandre F, Barkman B, Menutc C and Martin T, Naturally occurring bioactive compounds from four repellent essential oils against Bemisia tabaci whiteflie. Pest Manag Sci 72:179-189 (2015).
Deletre, E., Schatz, B., Bourguet, D., Chandre, F., Williams, L., Ratnadass, A. & Martin, T. (2016) Prospects for repellent in pest control: current developments and future challenges. Chemoecology, 26, 127-142.
Hori, M. (1998) Repellency of rosemary oil against Myzus persicae in a laboratory and in a screenhouse. Journal of Chemical Ecology, 24, 1425-1432.
Isman M B, Plant essential oils for pest and disease management. Crop Prot 19:603-608 (2000).
Jiang, H., Wang, J., Song, L., Cao, X., Yao, X., Tang, F. & Yue, Y. (2016a). GCxGC-TOFMS Analysis of Essential Oils Composition from Leaves, Twigs and Seeds of Cinnamomum camphora L. Presl and Their Insecticidal and Repellent Activities. Molecules 21(4): 423
Legeay, S., Clere, N., Apaire-Marchais, V., Faure, S. & Lapied, B. (2018). Unusual modes of action of the repellent DEET in insects highlight some human side effects. Eur J Pharmacol 825: 92-98
McCormick, A. C., Gershenzon, J. & Unsicker, S. B. (2014) Little peaks with big effects: establishing the role of minor plant volatiles in plant-insect interactions. Plant Cell Environ, 37, 1836-1844.
Obeng-Ofori D and Reichmuth C, Bioactivity of eugenol, a major component of essential oil of Ocimum suave (Wild.) against four species of stored-product Coleoptera. Int J Pest Manage 43:89-94 (1997).
Pascual-Villalobos M J, Canto-Tejero M, Vallejo R, Guirao P, Rodriguez-Rojo S and Cocero M J, Use of nanoemulsions of plant essential oils as aphid repellents. Ind Crop Prod 110:45-57 (2017).
Sun, H., Zhang, F., Chen, S., Guan, Z., Jiang, J., Fang, W. & Chen, F. (2015). Effects of aphid herbivory on volatile organic compounds of Artemisia annua and Chrysanthemum morifolium. Biochemical Systematics and Ecology 60: 225-233.
Thöming G, Knudsen G K. Attraction of pea moth Cydia nigricana to pea flower volatiles. Phytochemistry. 2014 April; 100:66-75. doi: 10.1016/j.phytochem.2014.01.005. Epub 2014 Feb. 5. PMID: 24508043.
Tomova B S, Waterhouse J S and Doberski J, The effect of fractionated Tagetes oil volatiles on aphid reproduction. Entomol Exp Appl 115:153-159 (2005).
von Arx M, Schmidt-Busser D, Guerin P M. Host plant volatiles induce oriented flight behaviour in male European grapevine moths, Lobesia botrana. J Insect Physiol. 2011 October; 57(10):1323-31. doi: 10.1016/j.jinsphys.2011.06.010. Epub 2011 Jun. 25. PMID: 21729701.
Webster, B., Bruce, T., Pickett, J. & Hardie, J. (2010). Volatiles functioning as host cues in a blend become nonhost cues when presented alone to the black bean aphid. Animal Behaviour 79(2): 451-457.
Zhang Q-H, Schneidmiller R G and Hoover D R, Essential oils and their compositions as spatial repellents for pestiferous social wasps. Pest Manag Sci 69:542-552 (2013).
Zhang, Z., Bian, L., Sun, X., Luo, Z., Xin, Z., Luo, F. & Chen, Z. (2014) Electrophysiological and behavioural responses of the tea geometrid Ectropis obliqua (Lepidoptera: Geometridae) to volatiles from a non-host plant, rosemary, Rosmarinus officinalis(Lamiaceae). Pest Management Science, 71, 96-104.
Zhang, R., Wang, B., Grossi, G., Falabella, P., Liu, Y., Yan, S., Lu, J., Xi, J. & Wang, G. (2017) Molecular Basis of Alarm Pheromone Detection in Aphids. Current Biology, 27, 55-61

1. Coated plant seed, wherein the coating contains a VOC mixture repellent for an airborne insect pest for said plant.

2. The coated plant seed according to claim 1, wherein the quantity of repellent VOC mixture per seed is 1 g to 50 g of repellent VOC mixture for 100,000 grains of seed.

3. The coated plant seed according to claim 1, wherein the repellent VOC mixture is a mixture repelling airborne insects selected from thrips (Thysanoptera), flea beetles, flies, olive moths (Acrolepiopsis), cochineals, noctuid moths and aphids.

4. The coated plant seed according to claim 1, wherein the plant is selected from a crop plant and a gardening gardens.

5. The coated plant seed according to claim 4, wherein the plant is selected from maize, wheat, barley, rapeseed, beetroot and pea, carrots, lettuce, leeks, chillies and tomatoes.

6. The coated plant seed according to claim 1, wherein the repellent VOC mixture is a combination of plants and airborne insect pests selected from: beetroot/aphid, lettuce/aphid, chillies/aphid, pea/aphid, tomato/thrips, carrot/fly, leak/fly, leak/olive moth, wheat/aphid, or wheat/fly, and rapeseed/flea beetle.

7. The coated plant seed according to claim 1, wherein the VOC mixture is a synthetic mixture.

8. The coated plant seed according to claim 7, wherein the repellent VOC mixture comprises at least a VOC selected from eugenol, linalool, cinnamaldehyde, para-cymene, gamma-terpinene, alpha-terpinene, alpha-phellandrene, epizingiberene, nerolidol, farnesol, geraniol, anisaldehyde, coumarin, methyl jasmonate, cis-jasmone, salicylaldehyde, alpha-pinene, eucalyptol, monoterpenoide citral, (E)-2-hexenal, and carvacrol.

9. The coated plant seed according to claim 8, wherein the repellent VOC mixture comprises at least linalool, eugenol and trans-cinnamaldehyde, wherein the linalool/eugenol weight ratio ranges from ¼ to ⅔ and the trans-cinnamaldehyde/(linalool+eugenol) weight ratio ranges from 2/7 to 1/1.

10. The coated plant seed according to claim 9, wherein the airborne insect pest is an aphid.

11. The coated plant seed according to claim 7, wherein the plants is selected from Chenopodiaceae.

12. The coated plant seed according to claim 1, wherein the VOC mixture is a natural mixture.

13. The coated plant seed according to claim 12, wherein the natural mixture is selected from essential oils of rue, thyme, citronella (lemongrass) cumin, lavender, verbena, geranium, mint, eucalyptus, cedar, clove, rosemary, garlic, celery, juniper, nepeta, oregano, cymbopogon, pepper, cinnamon, Chinese cinnamon, caraway, Moldavian dragonhead, fennel, hyssop, lemon balm, basil, sage, coriander, clove tree, Neem tree, French marigold and dill, and mixtures thereof.

14. Plant grown from the coated plant seed according to claim 1, wherein the plant is repellent for an airborne insect pest liable to affect said plant.

15. Method for protecting a plant against damage caused by airborne insect pests, which comprises coating seeds of the plant with a VOC mixture repelling airborne insect pests liable to affect said plant.

16. The method according to claim 15, wherein the VOC mixture is a synthetic mixture or a natural mixture.

17. The method according to claim 15, wherein the plant is selected from a crop plant and gardening garden.

18. Method for producing a plant which is repellent for an airborne insect pest liable to affect said plant which comprises: a) coating a seed of the plant with a coating containing a repellent VOC mixture for an airborne insect pest liable to affect said plant; and b) allowing the plant to grow from the coated seed.

19. The method according to claim 18, wherein the VOC mixture is a synthetic mixture or a natural mixture.

20. The method according to claim 18, wherein the plants is selected from a crop plant and gardening garden.
